(19) United States
(12) Patent Application Publication
(10) Pub. No.: US 2013/0229441 A1
(43) Pub. Date: Sep. 5, 2013

(54) PORTABLE DISPLAY DEVICE, AND METHOD FOR CONTROLLING OPERATION OF SAME

(71) Applicant: FUJIFILM CORPORATION, Tokyo (JP)

(72) Inventor: Hironori YANO, Tokyo (JP)

(73) Assignee: Fujifilm Corporation, Tokyo (JP)

(21) Appl. No.: 13/865,861

(22) Filed: Apr. 18, 2013

Related U.S. Application Data
(63) Continuation-in-part of application No. PCT/JP2011/074085, filed on Oct. 13, 2011.

(30) Foreign Application Priority Data
Oct. 26, 2010 (JP) 2010-239596

(51) Int. Cl. G09G 5/34

(52) U.S. Cl. CPC G09G 5/34
USPC 345/684

(57) ABSTRACT

It is arranged so that one can discern a sentence being read. To accomplish this, a sentence of interest to be read by a user is decided from within a document image, which is a document that has been converted to an image. The position of a display area is decided in the document image in such a manner that the area will contain the sentence of interest that has been decided. The sentence of interest that has been decided is displayed in highlighted form so that it can be distinguished from other sentences. The sentence highlighted is enclosed by a frame and indicated by hatching. The sentence of interest is displayed in highlighted form even when scrolling is performed. Thus the user can more readily discern the sentence that the user is reading.

### TECHNICAL FIELD

This invention relates to a portable control device and to a method for controlling the operation of this device.

### BACKGROUND ART

There is a device in which, when a document is displayed on a display screen, user-designated text is enlarged so as to facilitate reading of the document (Japanese Patent Application Laid-Open No. 2008-250948). Further, there is a device in which scrolling is performed automatically in accordance with the reading speed of the user (Japanese Patent Application Laid-Open No. 2001-282414). However, in a case where an imaged document is displayed on a small-size display screen as on a display screen provided on a mobile telephone, there are instances where one cannot discern which portion of the document is being read.

### DISCLOSURE OF THE INVENTION

An object of the present invention is to arrange it so that when an imaged document is displayed on a display screen, one can discern which portion of the document is being read.

A portable display device according to the present invention is characterized by comprising: portion-of-interest decision device for deciding, from within a document image representing an imaged document, a sentence of interest or a paragraph of interest the form of display of which is to be changed from that of other sentences or paragraphs; display form changing device for changing the form of display of the sentence of interest or paragraph of interest, which has been decided by the portion-of-interest decision device, from the form of display of other sentences and paragraphs; a display device for displaying, on a display screen, a portion of the document image that includes at least a part of the sentence of interest or paragraph of interest the form of display of which has been changed by the display form changing device; scrolling device for scrolling, in response to a portion-of-interest scroll command, the portion of the document image displayed on the display screen; first determination device for determining, in response to scrolling by the scrolling device, whether the sentence of interest or paragraph of interest the form of display of which has been changed by the display form changing device has been displayed up to the end thereof on the display screen in accordance with character alignment sequence; and decision control device for controlling the portion-of-interest decision device, in response to a determination by the first determination device that the sentence of interest or paragraph of interest the form of display of which has been changed by the display form changing means has been displayed up to the end thereof on the display screen, in such a manner that a sentence or paragraph that follows the sentence of interest or paragraph of interest the form of display of which has been changed by the form changing device is decided upon as a sentence of interest or paragraph of interest.

The present invention provides also an operation control method suited to the portable display device described above. Specifically, the method comprises: portion-of-interest decision device deciding, from within a document image representing an imaged document, a sentence of interest or a paragraph of interest the form of display of which is to be changed from that of other sentences or paragraphs; display form changing device changing the form of display of the sentence of interest or paragraph of interest, which has been decided by the portion-of-interest decision device, from the form of display of other sentences and paragraphs; a display device displaying, on a display screen, a portion of the document image that includes at least a part of the sentence of interest or paragraph of interest the form of display of which has been changed by the display form changing device; scrolling device scrolling, in response to a portion-of-interest scroll command, the portion of the document image displayed on the display screen; first determination device determining, in response to scrolling by the scrolling device, whether the sentence of interest or paragraph of interest the form of display of which has been changed by the display form changing device has been displayed up to the end thereof on the display screen in accordance with character alignment sequence; and determination control device controlling the portion-of-interest decision device, in response to a determination by the first determination device that the sentence of interest or paragraph of interest the form of display of which has been changed by the display form changing device has been displayed up to the end thereof on the display screen, in such a manner that a sentence or paragraph that follows the sentence of interest or paragraph of interest the form of display of which has been changed by the form changing device is decided upon as a sentence of interest or paragraph of interest.

The present invention also provides a recording medium storing a computer-readable program for implementing the method of controlling the operation of the above-described portable display device. Furthermore, it may be arranged so that such a program is also provided.

In accordance with the present invention, a sentence of interest or a paragraph of interest the form of display of which is to be changed from that of other sentences or paragraphs is decided from within a document image representing an imaged document. The decided form of display of the sentence of interest or paragraph of interest is changed from the form of display of other sentences and paragraphs. A portion of the document image that includes at least a part of the sentence of interest or paragraph of interest the form of display of which has been changed is displayed on the display screen of a display unit. When a portion-of-interest scroll command is applied, the portion of the document image displayed on the display screen is scrolled. In response to such scrolling, it is determined whether the sentence of interest or paragraph of interest has been displayed up to the end thereof on the display screen in accordance with the alignment sequence of the characters. When the sentence of interest or paragraph of interest is displayed up to the end thereof on the display screen in accordance with the alignment sequence of the characters, a sentence or paragraph that follows the sentence of interest or paragraph of interest the form of display of which has been changed is decided upon as a new sentence of interest or paragraph of interest. The form of display of the new sentence of interest or paragraph of interest thus decided is displayed on the display screen upon being changed from the form of display of other sentences or paragraphs.

The sentence of interest or paragraph of interest is the sentence or paragraph being read by the user. Since the form of display of the sentence of interest or paragraph of interest is displayed so as to appear different from the form of display of other sentences or paragraphs, the user can easily discern the sentence or paragraph being read.

The device may further comprise a storage device for storing the position of a sentence of interest or paragraph of interest contained in a portion of the document image displayed last on the display screen; and second determination device for determining whether the position of a sentence of interest or paragraph of interest has been stored in the storage device. In this case, by way of example, the portion-of-interest decision device decides, in response to a determination by the second determination device that the position of a sentence of interest or paragraph of interest has been stored, that a sentence or paragraph that follows the position of the sentence of interest or paragraph of interest stored in the storage device is a sentence of interest or paragraph of interest, and decides, in response to a determination by the second determination device that the position of a sentence of interest or paragraph of interest has not been stored, that a first sentence or first paragraph of the document image is a sentence of interest or paragraph of interest.

The device may further comprise display control device for controlling the display device so as to display a portion of the document image on the display screen; and designation device for designating a desired sentence or desired paragraph from within the portion of the document image being displayed on the display screen under the control of the display control device. In this case, the portion-of-interest decision device decides for example that the desired sentence or desired paragraph designated by the designation device is a sentence of interest or paragraph of interest.

### BRIEF DESCRIPTION OF THE DRAWINGS

FIG. 1 is an overview of a document image communication system;

FIG. 2 is a block diagram illustrating the electrical configuration of a mobile telephone;

FIGS. 3 and 4 are block diagrams illustrating the electrical configuration of a document image server;

FIGS. 5 and 6 are flowcharts illustrating the processing procedure of a mobile telephone;

FIG. 7 is an example of a document image;

FIG. 8 is an example of layout information;

FIG. 9 is an example of a document image;

FIGS. 10 to 12 are examples of document images displayed on the display screen of a mobile telephone;

FIG. 13 is an example of a document image;

FIG. 14 is an example of a document image displayed on the display screen of a mobile telephone; and

FIGS. 15 and 16 are flowcharts illustrating a sentence-of-interest decision processing procedure.

### BEST MODE FOR CARRYING OUT THE INVENTION

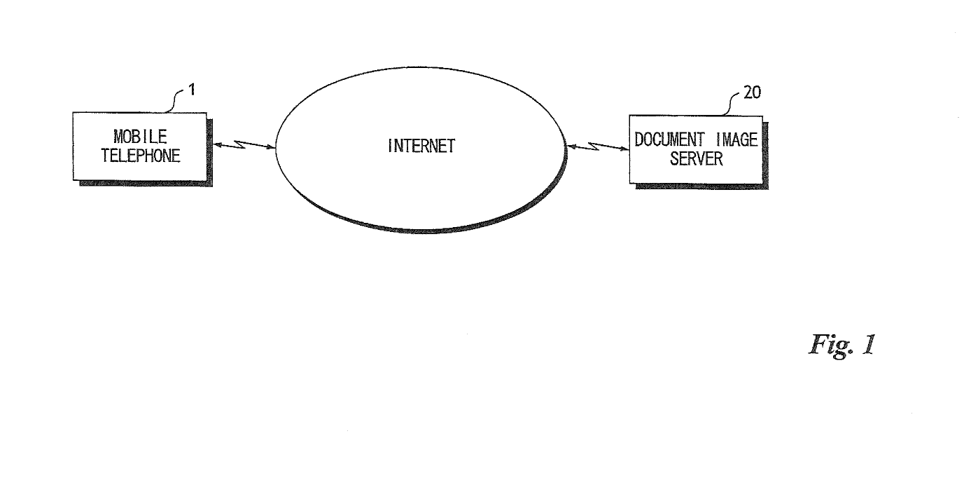

FIG. 1, which shows an embodiment of the present invention, illustrates an overview of a document image communication system (where the document is not one represented by a text file but one represented by an image file, and for this reason the image document is referred to as a “document image”).

The document image communication system according to this embodiment includes a mobile telephone 1 and a document image server 20 capable of communicating with each other via the Internet [the network is not limited to the Internet and may just as well be an in-house LAN (Local-Area Network) or the like]. A file representing a document image is transmitted from the document image server 20 to the mobile telephone 1 in response to a request from the mobile telephone 1.

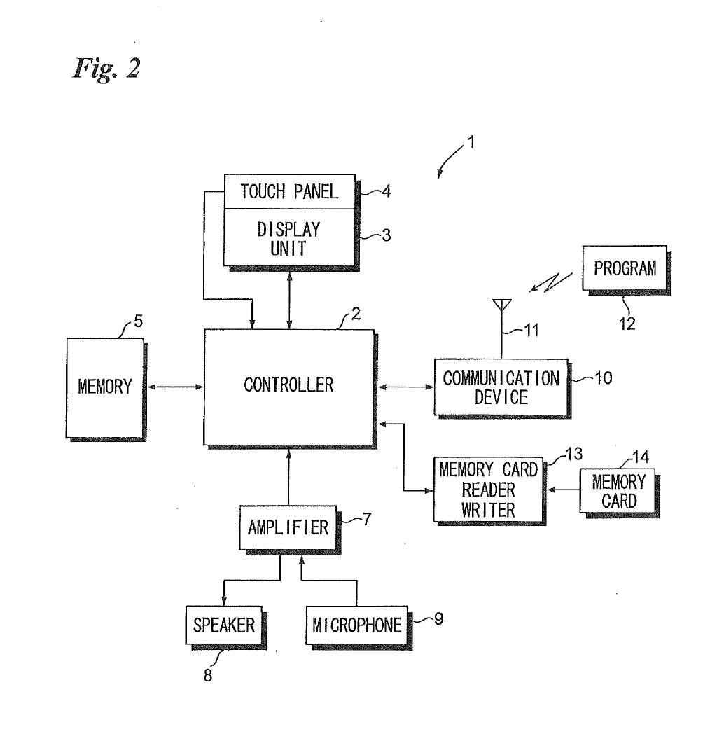

FIG. 2 is a block diagram illustrating the electrical configuration of the mobile telephone 1, referred to as a so-called “smart phone”.

The overall operation of the mobile telephone 1 is controlled by a control unit 2.

The mobile telephone 1 is provided with a communication device 10 and antenna 11 for communicating with other mobile telephones and for accessing the Internet. A program 12 for performing an operation described later is downloaded via the antenna 11. By installing the downloaded program 12 in the mobile telephone 1, the mobile telephone 1 will operate as described later. The mobile telephone 1 is provided with a memory card reader writer 13 as well. It may be arranged so that a program stored on a memory card 14 is read using the memory card reader writer 13 so that the program is installed in the mobile telephone 1.

The mobile telephone 1 is further provided with a display unit 3 for displaying documents and images and the like on a display screen. A touch panel 4 has been formed on the display screen of the display unit 3. By touching the touch panel 4 formed on the display screen, a user can apply various commands to the mobile telephone 1.

The mobile telephone 1 includes also a memory 5 in which prescribed data is stored. The mobile telephone 1 further includes a speaker 8 and a microphone 9. A voice signal is amplified by an amplifier circuit 7 and applied to the speaker 8, whereby voice is output from the speaker 8. Further, a voice signal representing voice that has been input from the microphone 9 is amplified by the amplifier circuit 7 and input to the control unit 2.

With the mobile telephone 1 according to this embodiment, a document image can be displayed on the display screen of the display unit 3 in the manner set forth above. Since the display screen of the mobile telephone 1 is comparatively small, the entirety of one sentence cannot be displayed on the display screen when character size is enlarged in order to facilitate the reading of characters. If the document is one represented by a text file, the characters need only be re-arrayed in conformity with the display screen. In the case of a document that is a document image, however, re-arraying characters in conformity with the display screen is difficult and, for this reason, scrolling is required. When scrolling is performed, however, there are occasions where one cannot discern which sentence (paragraph) of the document (paragraph) is being read. In this embodiment, which sentence (paragraph) is being read is made easy to discern.

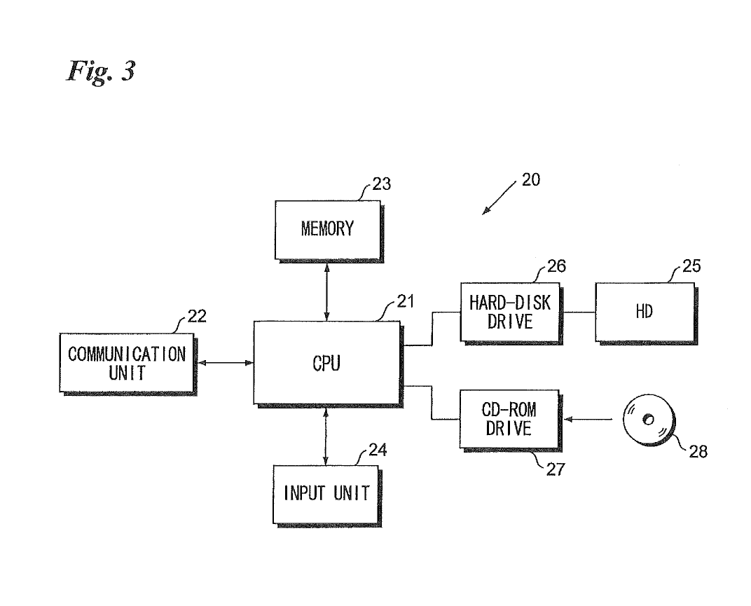

FIG. 3 is a block diagram illustrating the electrical configuration of the document image server 20.

The overall operation of the document image server 20 is controlled by a CPU 21.

The document image server 20 includes a communication unit 22 for accessing the Internet, a memory 23 for storing prescribed data and the like, an input unit 24 such as a keyboard, a hard disk 25, a hard-disk drive 26 for accessing the hard disk 25, and a CD-ROM (Compact-Disk Read-Only Memory) drive 27. A CD-ROM 28 storing a program for controlling an operation described later is loaded into the CD-ROM drive 27 and the program is read. The read program is installed in the document image server 20. The program may just as well be received via the Internet without being stored on a recording medium such as the CD-ROM 28.

A text file representing a document has been stored on the hard disk 25. The text file is read from the hard disk 25 and is converted by the CPU 21 to a document image file representing a document image. The document image file obtained by the conversion is stored on the hard disk 25.

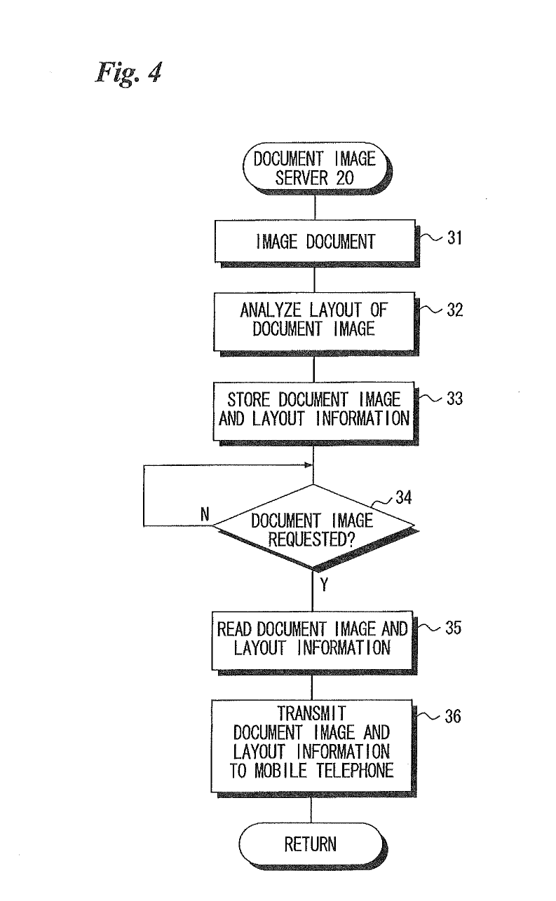

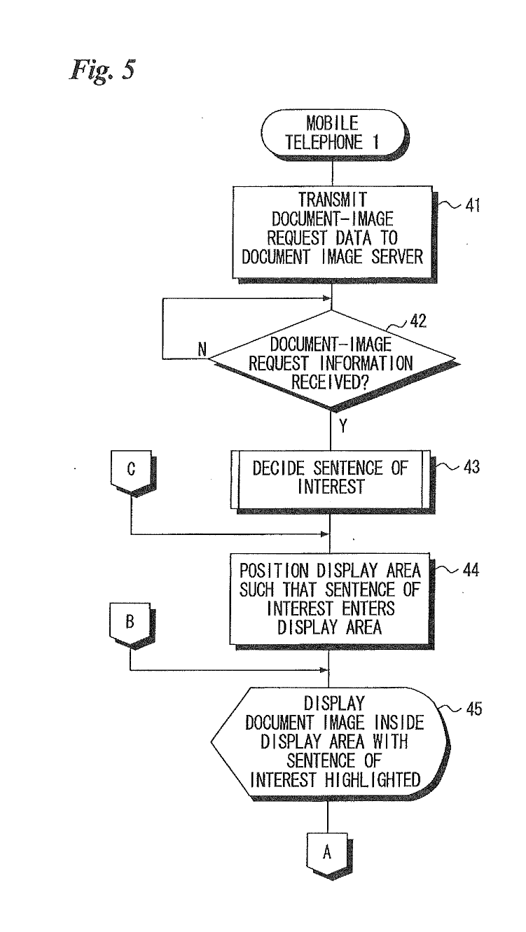

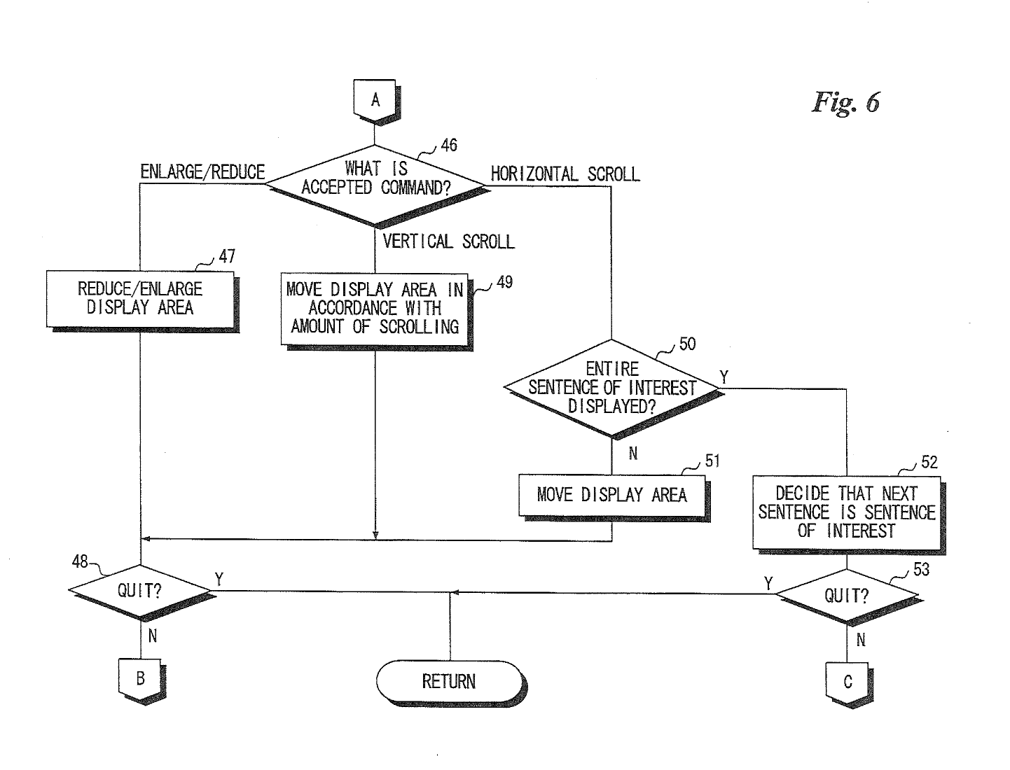

FIG. 4 is a flowchart illustrating the processing procedure of the document image server 20, and FIGS. 5 and 6 are flowcharts illustrating the processing procedure of the mobile telephone 1.

A document represented by a text file is imaged beforehand and converted to a document image, which is represented by an image file (document image file), in the document image server 20 (step 31 in FIG. 4). The layout of the document image obtained by the conversion is then analyzed (step 32 in FIG. 4). In layout analysis, such items as character alignment sequence (horizontal writing, vertical writing) of the document that has been converted to the document image and the position of each sentence constituting the document are detected.

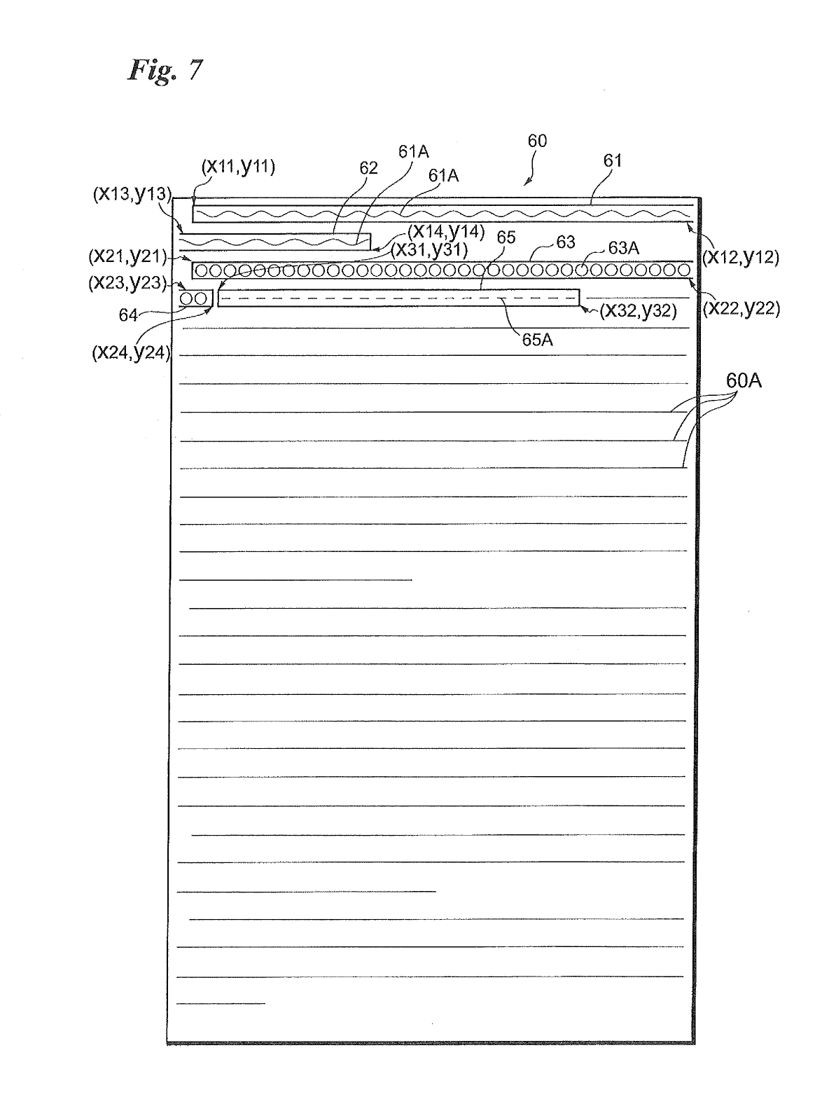

FIG. 7 is an example of a document image 60.

The document image 60 contains a number of sentences of horizontal writing. Among the sentences contained in the document image 60, a first sentence is represented by a wavy line 61A. A second sentence is represented by a series of round symbols 63A and a third sentence is represented by a dashed line 65A. Other sentences are represented by straight lines 60A. Since the sentences contained in the document image 60 are written horizontally, they are represented by horizontal straight lines 60A. Whether the alignment sequence of the characters is horizontal writing or vertical writing can be determined by detecting whether a blank space that occurs following the final sentence of a paragraph continues in the horizontal direction or in the vertical direction. Horizontal writing is determined if the blank space continues horizontally and vertical writing if the blank space continues vertically. Since the blank space in the document image 60 shown in FIG. 7 continues in the horizontal direction, it is determined that the writing is horizontal writing. Further, processing for detecting a period is executed and it is judged that a detected period is the end of a sentence. A character that follows a detected period is judged to be the beginning of a sentence.

When horizontal writing is determined, the positions of the beginning and end of the sentence are detected. If the position of the beginning of a sentence is that of horizontal writing, the position at the upper left of the character at the beginning of the sentence is detected by its coordinates. In the case of vertical writing, the position at the upper right of the character at the beginning of the sentence is detected by its coordinates. Regardless of whether the position of the end of the sentence is that of horizontal writing or vertical writing, the position of the period at the end of the sentence is detected by its coordinates. In a case where a sentence extends over two lines or more, the position of the character at the beginning of each line (the position is at the upper left of the character if writing is horizontal writing, and the position is at the upper right of the character if writing is vertical writing) and the position of the character at the end of each line (the position is at the upper right of the character if writing is horizontal writing, and the position is at the lower right of the character if writing is vertical writing) are also detected.

The first sentence 61A of the document image 60 shown in FIG. 7 is enclosed by frames 61 and 62. With regard to the position of the first sentence, the position of the beginning of sentence 61A has coordinates (x11, y11) and the position of the end of sentence 61A has coordinates (x14, y14). The first sentence 61A extends over two or more lines. The position of the final character on the first line has coordinates (x12, y12), and the position of the first character on the second line has coordinates (x13, y13). Accordingly, the positions of the first sentence 61A are indicated by (x11, y11), (x12, y12)+(x13, y13), (x14, y14). The second sentence 63A is enclosed by frames 63 and 64. In a manner similar to that of the first sentence 61A, the positions of the second sentence 63A are (x21, y21), (x22, y22)+(x23, y23), (x24, y24). The positions of the third sentence 65A are (x31, y31), (x32, y32). With regard to the other sentences 60A, the positions of these sentences 60A are detected in similar fashion. The fact that a sentence extends over multiple lines can be understood from the “+” symbol. A number obtained by adding “1” to the number of “+” symbols represents the number of lines over which the sentence extends. If the number of “+” symbols is zero, then the sentence does not extend over multiple lines and fits on one line of the document image 60. If the number of “+” symbols is one, the sentence extends over two lines of the document image 60, and if the number of “+” symbols is two, the sentence extends over three lines of the document image 60.

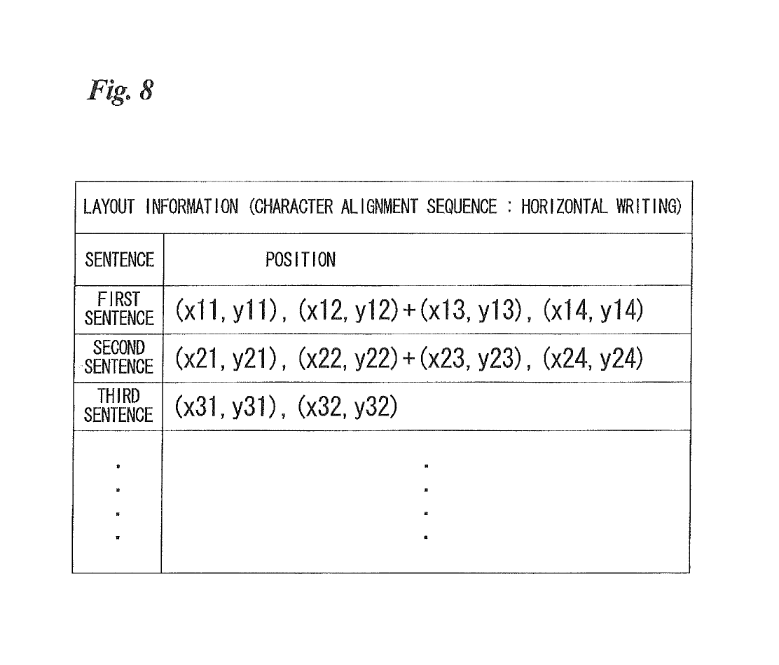

FIG. 8 is an example of layout information.

The layout information includes the positions of the sentences constituting the document image in addition to the data indicating the character alignment sequence (horizontal writing or vertical writing), as mentioned above. These positions are detected on a per-sentence basis in the manner described above. The layout information is generated as one set of information in association with one document image. It may be arranged so that the layout information is recorded in the header of the image file representing the document image or so that it is stored in a layout information file for accommodating the layout information. In a case where the layout information is stored in a layout information file separate from the image file, it would be necessary to place the information in the same folder or to make common use of part of the file name in such a manner that the layout information that corresponds to the image file can be identified.

Although the above-described layout analysis is carried out after the document is imaged, it may be arranged so that it is performed before the document is imaged. If considered from the standpoint of ease of layout analysis, analysis would be performed before the document is imaged. Naturally, even in a case where layout analysis is performed after the document is imaged, it may be arranged so that the layout analysis is performed utilizing the header information that has been stored in the header of the text file that represents the document prior to its imaging, as well as the text file itself.

With reference again to FIG. 4, when layout analysis ends, the document image and the layout information are stored on the hard disk 25 (step 33). If the document image and layout information are separate files, then the separate files are stored on the hard disk 25, and if the layout information has been placed in the header of the image file representing the document image, this image file is stored on the hard disk 25.

In a case where the document image is to be displayed on the mobile telephone 1, document-image request data is transmitted from the mobile telephone 1 to the document image server 20 (step 41 in FIG. 5).

When the document-image request data transmitted from the mobile telephone 1 is received at the document image server 20 (“YES” at step 34 in FIG. 4), the document image and layout information (the file representing it) specified by this request information are read from the hard disk 25 (step 35 in FIG. 4). The read document information and layout information (the file representing it) are transmitted from the document image server 20 to the mobile telephone 1 (step 36 in FIG. 5).

When the document image and layout information (the file representing it) transmitted from the document image server 20 are received at the mobile telephone 1 (“YES” at step 42 in FIG. 5), a sentence of interest is decided (step 43 in FIG. 5). A sentence of interest refers to a sentence thought to be one that will be read now or one that is being read by the user of the mobile telephone 1. For example, if the document image is displayed on the display screen of the mobile telephone 1 the first time, it is decided that the first sentence of this document image is the sentence of interest. If it is construed that the user of the mobile telephone 1 has finished reading the first sentence, then the second sentence, which follows the first sentence, becomes the sentence of interest, as will be described later. Processing for deciding the sentence of interest will be described in detail later.

When the sentence of interest is decided, the display area is positioned in such a manner that the decided sentence of interest falls within the display area (step 44 in FIG. 5). The document image within the display area is displayed on the display screen of the mobile telephone 1.

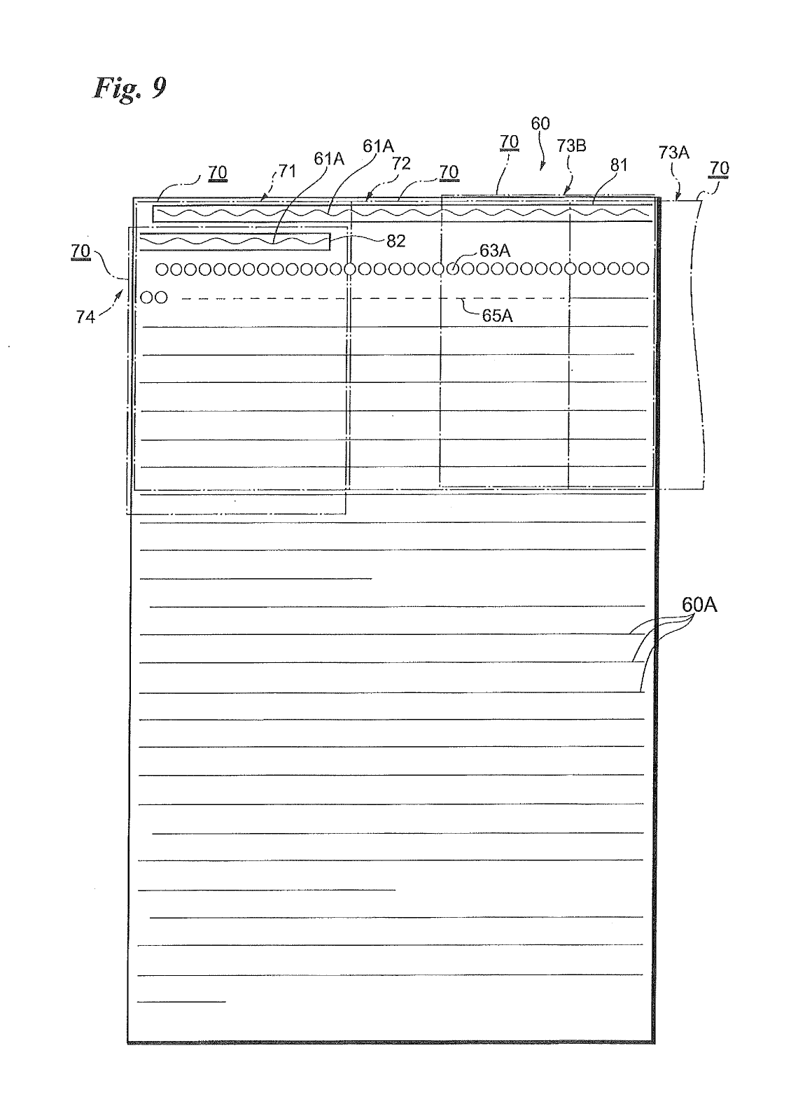

FIG. 9 illustrates the document image 60.

Assume that the first sentence 61A has been decided upon as the sentence of interest in the manner described above. The first sentence 61A extends from the first line to the second line and is enclosed by frames 81 and 82.

If the document image 60 has not been displayed even one time, then, as mentioned above, the first sentence 61A is decided as the sentence of interest and a display area 70 is positioned in such a manner that the left side of the character at the beginning of the sentence of interest becomes the left edge of the display area. If the character at the beginning of the sentence of interest is a blank space equivalent to one character owing to a paragraph change or the like, the display area 70 is positioned in such a manner that the left side of the blank space equivalent to one character becomes the left edge of the display area. Whether a blank space equivalent to one character is in front of a character at the beginning of the sentence of interest can be determined from the positions contained in the layout information as shown in FIG. 8 For example, since the x coordinate of the first character of the first sentence 61A is x11 and the x coordinate of the first character on the second line of the first sentence 61A is x13 (the first x coordinate of the “+” symbol), then it can be determined whether the blank space is in front of the first character of the first sentence 61A by comparing these x coordinates x11 and x13. For example, there is blank space present if x11>x13 holds and there is no blank space present if x11=x13 holds. Thus, if the document image 60 has not been displayed even once, the display area 70 is positioned at a position 71 at the upper left of the document image 60.

When the display area is positioned, the document image 60 within the display area 70 is displayed on the display screen of the mobile telephone 1 in such a manner that the sentence of interest is highlighted relative to other sentences (step 45 in FIG. 5).

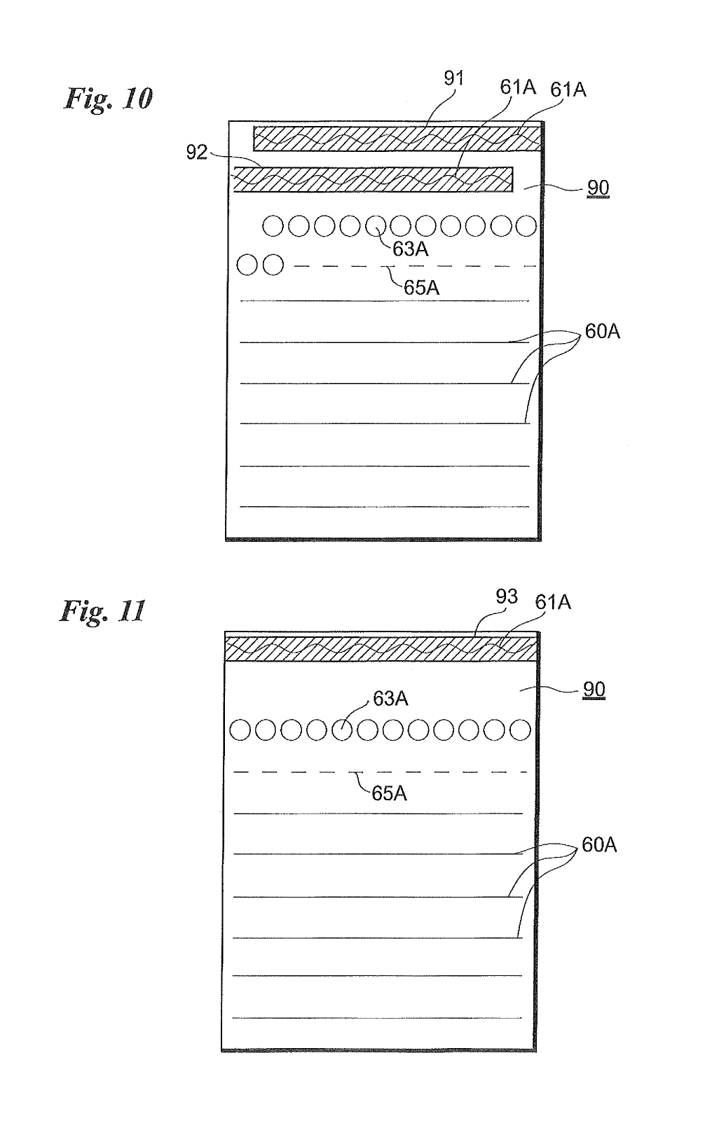

FIG. 10 is an example of a display screen 90 of the mobile telephone 1.

The portion inside the display area 70 from within the document image 60 is being displayed on the display screen 90. Also being displayed on the display screen 90 is a portion of the first sentence 61A, which is the sentence of interest decided in the manner described above. This portion of the first sentence 61A is displayed in highlighted form (indicated by the hatching) as if it were enclosed by frames 91 and 92. Since the sentence of interest is highlighted, the user of the mobile telephone 1 can identify which sentence should be read among the number of sentences being displayed on the display screen 90.

With reference to FIG. 6, the mobile telephone 1 accepts a command from the user (step 46).

The display area 70 is reduced in size if the command is an enlargement command and is enlarged in size if the command is a reduction command (step 47). If a quit command is not applied (“NO” at step 48), the display area 70 is reduced in case of the enlargement command and therefore a portion of the enlarged document image 60 is displayed on the display screen of the mobile telephone 1. In case of the reduction command, the display area 70 is enlarged and therefore a portion of the reduced document image 60 is displayed on the display screen of the mobile telephone 1 (step 45 in FIG. 5). It goes without saying that in the case of the enlargement command, the display area 70 is reduced in such a manner that the sentence of interest is included in the portion of the display after the enlargement thereof.

If the command is a vertical scroll command (applied by sliding a finger or touch pen or the like upward or downward on the surface of the touch panel 4), the display area 70 is moved up or down in accordance with the amount of scrolling (step 49). If a quit command is not applied (“NO” at step 48), the portion of the document image 60 that is contained in the display area 70 after the movement thereof is displayed on the display screen 90 (step 45 in FIG. 5). In a case where the sentence of interest is no longer contained in the moved display area 70 owing to vertical scrolling, it is preferred that the sentence in the portion contained in the moved display area 70 be decided upon as a new sentence of interest. For example, the portion of a sentence to be made the sentence of interest is designated by the user from among sentences (portions thereof) being displayed on the display screen 90. Naturally, even in a case where the sentence of interest is no longer contained in the display area 70 after movement thereof owing to vertical scrolling, the sentence of interest need not be changed.

If the command is a horizontal scroll command (applied by sliding a finger or touch pen or the like leftward or rightward on the surface of the touch panel 4), it is determined whether the entire sentence of interest has been displayed in its entirety in accordance with the character alignment sequence (step 50 in FIG. 6).

If the entire sentence of interest has not been displayed (“NO” at step 50 in FIG. 6), the display area 70 is moved in the scrolling direction by an amount equivalent to the width of the display area 70 (step 51 in FIG. 6). For example, the display area 70 is moved rightward (or leftward) if a finger or touch pen or the like is slid rightward on the surface of the touch panel 4 and is moved leftward (or rightward) if a finger or touch pen or the like is slid leftward on the surface of the touch panel 4. As a result, the display area 70 moves to a position indicated at 72 shown in FIG. 9. If a quit command is not applied (“NO” at step 48), the portion inside the display area 70 at the position indicated at 72 within the document image 60 is displayed on the display screen 90 (step 45 in FIG. 5).

FIG. 11 is an example of the document image 60 displayed on the display screen 90.

The document image 60 inside the display area 70 in the case where the display area 70 has been moved to the position indicated at 72, as shown in FIG. 9, is being displayed on the display screen 90. The sentence of interest is enclosed by a frame 93 on the display screen 90 in a manner similar to that shown in FIG. 10. The sentence of interest is being displayed in highlighted form as indicated by the hatching. Since the sentence of interest is thus highlighted, the user can discern the sentence the user is reading even though a number of sentences are being displayed on the small display screen.

With reference again to FIG. 6, if further horizontal scrolling is performed and the entire sentence of interest has not been displayed in accordance with the character alignment sequence (step 50), then the display area 70 is moved (step 51).

In a case where the display area 70 is the position indicated at 72, as illustrated in FIG. 9, moving the display area 70 rightward by the width of the display area 70 will bring the position of the display area 70 to that indicated at 73A. Since the document image 60 now is no longer on the right side internally of the display area 70, the document image 60 is no longer displayed on the right-side portion of the display screen of mobile telephone 1. For this reason it may be arranged so that the range of movement of the display area 70 is limited to be within the document image 60. If a rightward horizontal scroll command is applied in a case where the display area 70 is at the position indicated at 72, the position of the display area 70 where the right edge of the display area 70 and the right edge of the document image 60 coincide, as indicated at 73B, will be taken as the limit on movement of the display area 70.

If, when the display area 70 has attained the position indicated by 73A or 73B shown in FIG. 9, a scroll command for further rightward scrolling is applied and, moreover, the entire sentence of interest has not been displayed on the display screen 90 in the character alignment sequence (“NO” at step 50), then the display area 70 is moved so as to bring the left edge of the display area 70 into coincidence with the left edge of the document image 60 (step 51). Further, the display area 70 is moved downward by one line. As a result, the display area 70 attains the position indicated at 74. Naturally, if the sentence of interest is contained in the display area 70 after the movement of the display area, then the display area 70 need not necessarily be moved one line downward.

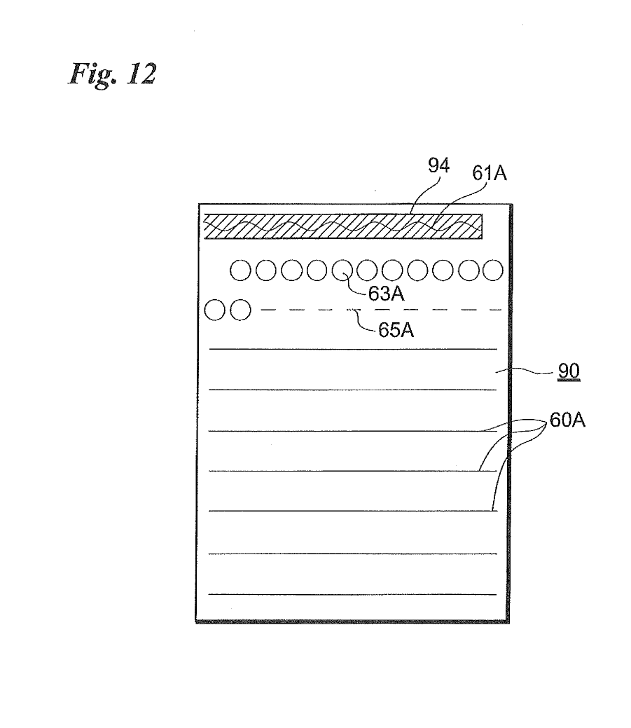

FIG. 12 is an example of the document image 60 displayed on the display screen 90.

The document image 60 within the display area 70 is being displayed on the display screen 90 at the position indicated at 74 in FIG. 9. The sentence of interest enclosed by a frame 94 is displayed in highlighted form as indicated by the hatching.

By moving the display area 70 in the manner indicated by the reference numerals 71, 72, 73A or 73B and 74 in FIG. 9, the first sentence 61A taken as the sentence of interest will be displayed in its entirety in accordance with the alignment sequence of its characters. Since the first sentence 61A taken as the sentence of interest is displayed in highlighted form, the user can discern the sentence the user is reading even if the document image 60 is scrolled.

As to whether the entire sentence of interest has been displayed in its entirety in accordance with the character alignment sequence can be determined using the position information contained in the layout information shown in FIG. 8. That is, since the position information contained in the layout information is in accordance with the character alignment sequence, the characters specified by these positional coordinates are displayed in the order of the position information. As a result, the fact that the sentence of interest has been displayed in accordance with the character alignment sequence can be determined. Owing to the fact that the character having the coordinates at the beginning of the positional coordinates [namely (x11, y11) in the case of the first sentence 61A] is displayed first, the sentence of interest is displayed in accordance with the order of the positional coordinates and finally the character having the final coordinates of the positional coordinates [namely (x14, y14) in the case of the first sentence 61A] is displayed last, it can be determined that the entire sentence of interest has been displayed in its entirety in accordance with the character alignment sequence.

If the entire sentence of interest is displayed in its entirety in accordance with the character alignment sequence (“YES” at step 50 in FIG. 6), then it is decided that the sentence that follows the sentence that was the sentence of interest is now the sentence of interest (step 52 in FIG. 6). If a quit command is not applied (“NO” at step 53 in FIG. 6), then the display area 70 is positioned so as to bring the decided sentence of interest into the display area 70 (step 44 in FIG. 6).

Thus, when display of the first sentence 61A ends, the second sentence 63A is decided upon as the sentence of interest.

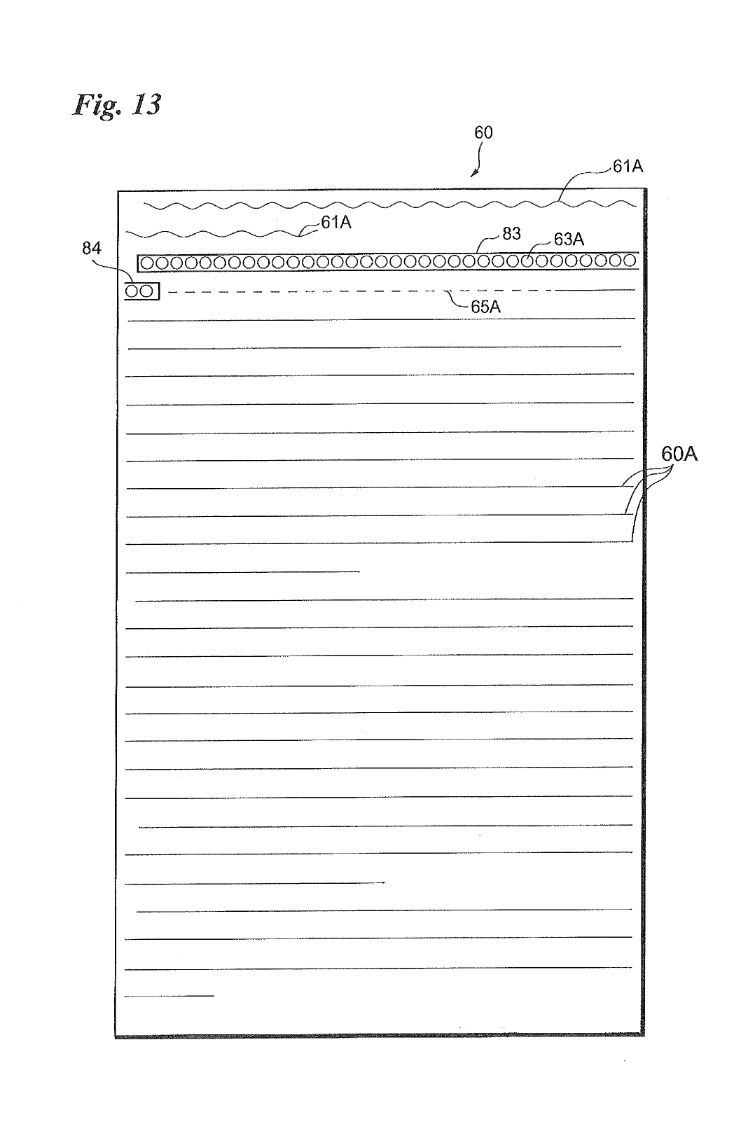

FIG. 13 is an example of the document image 60.

The second sentence 63A that has been decided is enclosed by frames 83 and 84. The position of the display area 70 is decided so as to contain a portion of the second sentence 63A decided. Since the second sentence 63A is included in the document image 60 being displayed on the display screen 90 when the display of the first sentence 61A ends, as shown in FIG. 12, it is decided the position of the display area 70 when the display of the first sentence 61A ends (the position indicated at 74 shown in FIG. 9) is the position of the display area 70 as is.

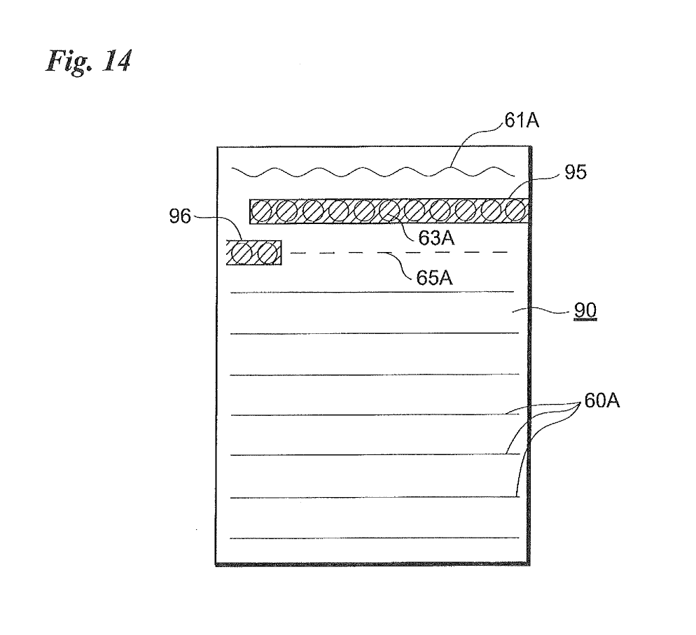

FIG. 14 is an example of the display screen 90.

As will be understood from a comparison with FIG. 12, the content of the document image 60 being displayed on the display screen 90 shown in FIG. 14 is the same as that of the document image 60 being displayed on the display screen 90 shown in FIG. 12. In FIG. 12, however, the sentence of interest is the first sentence 61A and therefore the first sentence 61A is highlighted as indicated by frame 94. In FIG. 14, on the other hand, the sentence of interest is the second sentence 63A and therefore the second sentence 63A is highlighted as indicated by frames 95 and 96.

With regard to the second sentence 63A as well, as was the case with the first sentence 61A, it is highlighted in such a manner that the user can discern the sentence being read even though scrolling is performed, as described above.

In the foregoing embodiment, the display area 70 is moved horizontally by the width of the display area 70 with regard to the horizontal scroll command. However, it may be arranged so that the display area 70 is moved by an amount that conforms to the amount of scrolling (the length traced on the surface of the touch panel 4).

In the foregoing embodiment, the mobile telephone 1 can be provided with an enlargement button, a reduction button, vertical scroll buttons (an up-arrow button and a down-arrow button) and horizontal scroll buttons (a left-arrow button and a right-arrow button) for the enlargement/reduction command, vertical scroll command and horizontal scroll command, respectively, and these scroll operations can be achieved in accordance with commands from these buttons.

In the foregoing embodiment, the document image is an image of horizontal writing. When a vertical scroll command is applied, therefore, the display area 70 moves in accordance with the amount of scrolling without execution of determination processing (the processing at step 50 in FIG. 6) for determining whether the entire sentence of interest has been displayed. If the horizontal scroll command is then applied, the determination as to whether the entire sentence of interest has been displayed would be performed. However, in the case of a document image that is vertical writing, determination processing for determining whether the entire sentence of interest has been displayed would be executed by applying the vertical scroll command. If the horizontal scroll command is then applied, the determination as to whether the entire sentence of interest has been displayed would not be performed.

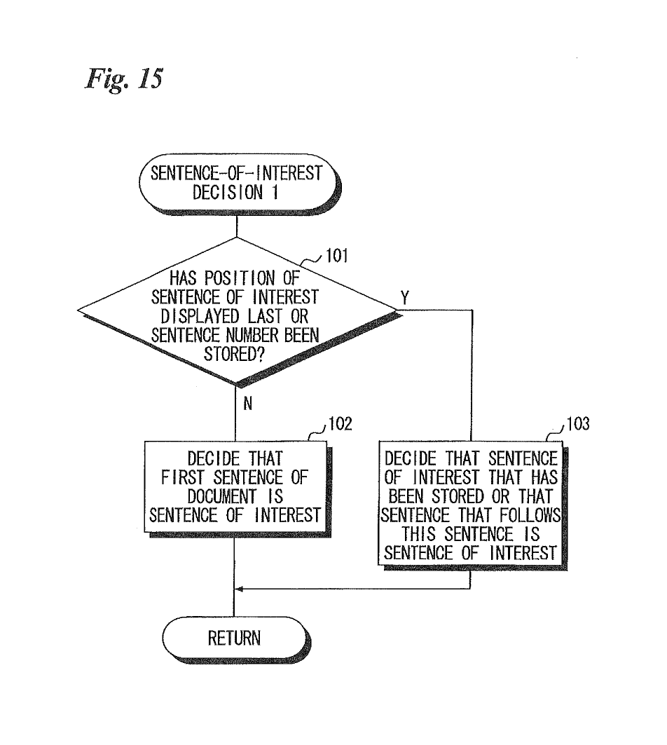

FIG. 15 is a flowchart illustrating a processing procedure for deciding a sentence of interest (the processing at step 43 of FIG. 5).

The processing procedure shown in FIG. 15 is such that if display of the document image 60 is quit in mid-course, the above-described highlighted display can be continued from the portion at which the display was quit. If the display of the document image 60 is quit in mid-course, therefore, the sentence of interest that was displayed last before the display was quit is stored in terms of the number of the sentence. Instead of storing the sentence of interest in terms of the number of the sentence, the position of this sentence of interest in the document image 60 may be stored. If the position is stored, the number of the sentence of interest can be determined from the layout information. If the number of the sentence can be determined, then so can the position of this sentence. Information indicating the position or the sentence number need only be appended updatably to the above-mentioned layout information.

If data indicating the position of the sentence of interest or the sentence number of the sentence of interest has been stored (“YES” at step 101), the sentence of interest specified by the stored data indicating the position or sentence number, or the sentence that follows this sentence, is decided upon as the sentence of interest (step 103). If the entirety of the sentence of interest specified by the stored data indicating the position or sentence number has been displayed, then it is deemed that the user has finished reading this sentence of interest and, hence, the sentence of interest that follows the sentence of interest displayed last is decided upon as the sentence of interest. If the entirety of the sentence of interest specified by the stored data indicating the position or sentence number has not been displayed, then it is deemed that the user has not finished reading this sentence of interest. The sentence of interest displayed last, therefore, is again decided upon as the sentence of interest.

If, on the other hand, data indicating the position of the sentence of interest or the sentence number of the sentence of interest has not been stored (“NO” at step 101), then the first sentence of the document image is decided upon as the sentence of interest (step 102).

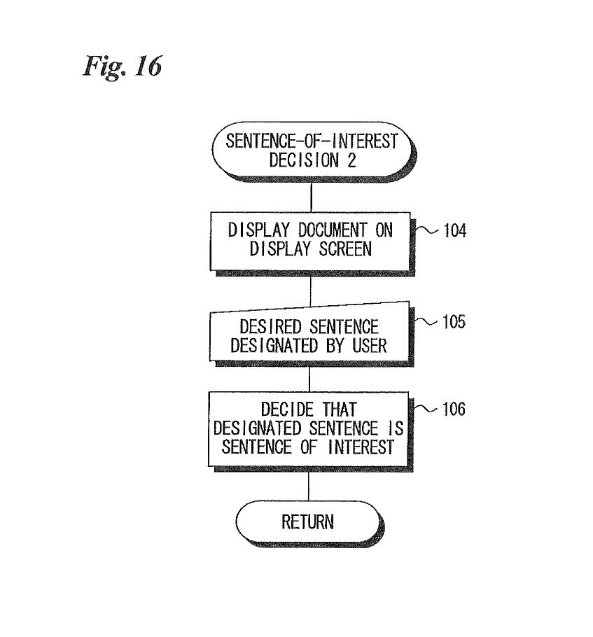

FIG. 16 is another flowchart illustrating a processing procedure for deciding a sentence of interest (the processing at step 43 of FIG. 5).

A part or all of the document image 60 is displayed on the display screen of the mobile telephone 1 (step 104). A desired sentence from among the sentences displayed on the display screen is touched using a finger or touch pen, whereby the sentence is designated (step 105). The designated sentence is decided upon as the sentence of interest (step 106). It goes without saying that scroll processing is executed as needed in such a manner that the desired sentence is displayed on the display screen.

In the foregoing embodiment, the unit of highlighting is the sentence. However, it may be arranged so that highlighting is performed on a per-paragraph basis. If highlighting is performed on a per-paragraph basis, the position information in the layout information also would be stored on a per-paragraph basis. Further, the comma in a sentence may be adopted as the unit of highlighting.

Further, in the foregoing embodiment, the sentence of interest is highlighted. However, this does not impose a limitation and it will suffice if a sentence of interest (paragraph of interest) can be made distinguishable from other sentences (paragraphs). For example, the font of the sentence of interest can be made different from the font of other sentences, or the font can be italicized. In a case where the font is changed or italicized, it will suffice if character recognition processing is applied to the document image as necessary, the document represented by a text file is restored, the font in the text file is changed or italicized and then the document is again converted to an image.

1. A portable display device comprising:
portion-of-interest decision device for deciding, from within a document image representing an imaged document, a sentence of interest or a paragraph of interest the form of display of which is to be changed from that of other sentences or paragraphs;
display form changing device for changing the form of display of the sentence of interest or paragraph of interest, which has been decided by said portion-of-interest decision device, from the form of display of other sentences and paragraphs;
a display device for displaying, on a display screen, a portion of the document image that includes at least a part of the sentence of interest or paragraph of interest the form of display of which has been changed by said display form changing device;
scrolling device for scrolling, in response to a portion-of-interest scroll command, the portion of the document image displayed on the display screen;
first determination device for determining, in response to scrolling by said scrolling device, whether the sentence of interest or paragraph of interest the form of display of which has been changed by said display form changing device has been displayed up to the end thereof on the display screen in accordance with character alignment sequence; and
decision control device for controlling said portion-of-interest decision device, in response to a determination by said first determination device that the sentence of interest or paragraph of interest the form of display of which has been changed by said display form changing device has been displayed up to the end thereof on the display screen, in such a manner that a sentence or paragraph that follows the sentence of interest or paragraph of interest the form of display of which has been changed by said display form changing device is decided upon as a sentence of interest or paragraph of interest.

2. A portable device according to claim 1, further comprising:
a storage device for storing the position of a sentence of interest or paragraph of interest contained in a portion of the document image displayed last on the display screen; and
second determination device for determining whether the position of a sentence of interest or paragraph of interest has been stored in said storage device;
wherein said portion-of-interest decision device decides, in response to a determination by said second determination device that the position of a sentence of interest or paragraph of interest has been stored, that a sentence or paragraph that follows the position of the sentence of interest or paragraph of interest stored in the storage device is a sentence of interest or paragraph of interest, and decides, in response to a determination by said second determination device that the position of a sentence of interest or paragraph of interest has not been stored, that a first sentence or first paragraph of the document image is a sentence of interest or paragraph of interest.

3. A portable display device according to claim 2, further comprising:
display control device for controlling said display device so as to display a portion of the document image on the display screen; and
designation device for designating a desired sentence or desired paragraph from within the portion of the document image being displayed on the display screen under the control of said display control device;
wherein said portion-of-interest decision device decides that the desired sentence or desired paragraph designated by said designation device is a sentence of interest or paragraph of interest.

4. A method of controlling operation of a portable display device, comprising:
portion-of-interest decision device deciding, from within a document image representing an imaged document, a sentence of interest or a paragraph of interest the form of display of which is to be changed from that of other sentences or paragraphs;
display form changing device changing the form of display of the sentence of interest or paragraph of interest, which has been decided by the portion-of-interest decision device, from the form of display of other sentences and paragraphs;
a display device displaying, on a display screen, a portion of the document image that includes at least a part of the sentence of interest or paragraph of interest the form of display of which has been changed by the display form changing device;
scrolling device scrolling, in response to a portion-of-interest scroll command, the portion of the document image displayed on the display screen;
first determination device determining, in response to scrolling by the scrolling device, whether the sentence of interest or paragraph of interest the form of display of which has been changed by the display form changing device has been displayed up to the end thereof on the display screen in accordance with character alignment sequence; and
determination control device controlling the portion-of-interest decision means, in response to a determination by the first determination device that the sentence of interest or paragraph of interest the form of display of which has been changed by the display form changing device has been displayed up to the end thereof on the display screen, in such a manner that a sentence or paragraph that follows the sentence of interest or paragraph of interest the form of display of which has been changed by the form changing device is decided upon as a sentence of interest or paragraph of interest.

5. A recording medium storing computer-readable program for controlling a computer of a portable display device so as to:
decide, from within a document image representing an imaged document, a sentence of interest or a paragraph of interest the form of display of which is to be changed from that of other sentences or paragraphs;
change the form of display of the sentence of interest or paragraph of interest, which has been decided, from the form of display of other sentences and paragraphs;
display, on a display screen, a portion of the document image that includes at least a part of the sentence of interest or paragraph of interest the form of display of which has been changed;
scroll, in response to a portion-of-interest scroll command, the portion of the document image displayed on the display screen;
determine, in response to scrolling, whether the sentence of interest or paragraph of interest the form of display of which has been changed has been displayed up to the end thereof on the display screen in accordance with character alignment sequence; and
control, in response to a determination that the sentence of interest or paragraph of interest the form of display of which has been changed has been displayed up to the end thereof on the display screen, in such a manner that a sentence or paragraph that follows the sentence of interest or paragraph of interest the form of display of which has been changed is decided upon as a sentence of interest or paragraph of interest.
